(19) United States
(12) Patent Application Publication
(10) Pub. No.: US 2025/0355221 A1
(43) Pub. Date: Nov. 20, 2025

(54) OPTICAL DEVICE WITH THERMALLY CONDUCTIVE FINGERS AND RELATED METHOD

(71) Applicants: UNIVERSITY OF CENTRAL FLORIDA RESEARCH FOUNDATION, INC., ORLANDO, FL (US); The U.S.A. as represented by the secretary of the Navy, Arlington, VA (US)

(72) Inventors: Aravinda Kar, Orlando, FL (US); Chandraika Sugrim, Saint Augustine, FL (US)

(21) Appl. No.: 19/283,816

(22) Filed: Jul. 29, 2025

Related U.S. Application Data
(63) Continuation of application No. 17/451,376, filed on Oct. 19, 2021, now Pat. No. 12,399,346.
(60) Provisional application No. 63/093,827, filed on Oct. 20, 2020.

(51) Int. Cl. G02B 7/18; G02B 7/195; H01S 3/04

(52) U.S. Cl. CPC G02B 7/1815; G02B 7/195; H01S 3/0401

(57) ABSTRACT

An optical device includes a base layer, and active layers on the base layer and having optical IC devices. The optical device also includes a cover layer over the base layer and encapsulating the optical IC devices, the base layer and the cover layer each having a glass material.

### RELATED APPLICATION

This application is a continuation application of application Ser. No. 17/451,376 filed Oct. 19, 2021, which is based upon based upon prior filed copending Application No. 63/093,827 filed Oct. 20, 2020, the entire subject matter of which is incorporated herein by reference in its entirety.

### GOVERNMENT RIGHTS

This invention was made with government support under contract number N6893620C0014 awarded by the United States Department of the Navy. The government has certain rights in the invention.

### TECHNICAL FIELD

The present disclosure relates to the field of optics, and, more particularly, to an optical device and related methods.

### BACKGROUND

For almost two centuries, the optical community has been using a typical method of producing refractive lenses and optically transparent windows. The method starts with an optical blank that is cut, ground, and then polished/lapped to form the final optic. While this process is well suited to the simplest optics, those with a combination of planar and spherical curved surfaces, modern demands for high-definition optics are pushing the limitations of this centuries-old technology. Spherical lenses suffer from spherical aberration, which is a kind of blur caused by imperfect focusing.

Modern refractive lenses have aspheric surfaces to correct spherical and other aberrations in the lens system—the surface curvature is not constant across the aperture, as is the case for spherical surfaces. This is usually defined mathematically as the sum of a first-order curvature having a constant radius (i.e., a spherical surface) and a series of aspheric terms (i.e., intentional deviations from the spherical surface).

The more aspheric a surface, the higher order the optic. This involves more manufacturing complexity and costly modern methods of manufacture, such as computer-controlled precision polishing, single-point diamond turning (SPDT), or precision glass molding. Even these methods are somewhat limited in that they require the surfaces have rotational or translational symmetry and are not suitable for asymmetric, or freeform, surfaces.

### SUMMARY

Generally, an optical device comprises a base layer, and a plurality of active layers on the base layer and comprising a plurality of optical integrated circuit (IC) devices. The optical device also includes a cover layer over the base layer and encapsulating the plurality of optical IC devices. The base layer and the cover layer each comprises a glass material.

Also, the plurality of active layers may be configured to change a refractive index based upon an applied voltage. The base layer and the plurality of active layers may each comprise nanoparticles. Each of the plurality of optical IC devices may include one of a light emitted diode (LED), a photodetector, and a variable optical attenuator. Each of the plurality of optical IC devices may comprise one of a liquid crystal (LC) cell and a high definition optical device. The optical device may also include a plurality of bus lines the base layer. Each of the plurality of bus lines may include a nanometer bus line.

The plurality of active layers may comprise at least one of a metal material, a semiconductor material, a ceramic material, a polymer material, and an optically transparent electrically conductive material. The optical transparent electrically conductive material may comprise indium tin oxide.

Another aspect is directed to a method for making an optical device. The method comprises depositing nanoparticles of a first material via an additive manufacturing process to form a base layer, and depositing nanoparticles of a second material via an additive manufacturing process to form a plurality of active layers on the base layer, the plurality of active layers comprising a plurality of optical IC devices. The method also includes depositing nanoparticles of a second material via an additive manufacturing process to form a cover layer over the base layer and encapsulating the plurality of optical IC devices. The base layer and the cover layer each comprises a glass material.

### BRIEF DESCRIPTION OF THE DRAWINGS

FIG. 1 is a schematic partially transparent side view of an optical element, according to the present disclosure.

FIG. 2 is a schematic perspective view of the optical element of FIG. 1.

FIG. 3 is a schematic cross-section view of the optical element of FIGS. 1-2 along line 3-3.

FIG. 4 is a schematic partially transparent perspective view of an optical device, according to a first embodiment of the present disclosure.

FIG. 5 is a schematic partially transparent side view of the optical device of FIG. 4.

FIG. 6 is a schematic top plan view of the optical element of FIG. 4.

FIG. 7 is a schematic bottom plan view of the optical element of FIG. 4.

FIG. 8A is a schematic cross-section view of the optical body of FIGS. 4-7 along line 8-8.

FIG. 8B is a schematic cross-section view of the optical device of FIGS. 4-7 along line 8-8.

FIG. 9 is a schematic cross-section view of the optical device of FIGS. 4-7 along line 9-9.

FIG. 10 is a schematic perspective view of an optical device, according to a second embodiment of the present disclosure.

FIG. 11 is a schematic perspective view of an optical device, according to a third embodiment of the present disclosure.

FIG. 12 is a schematic diagram of an optical device, according to a fourth embodiment of the present disclosure.

FIG. 13 is a schematic cross-section view of an optical device, according to a fifth embodiment of the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

Generally, an optical element may include a lens body having first and second opposing curved sides, and an annular flange being integral with the lens body and extending radially from the lens body. The annular flange may be parallel with a lens center axis and perpendicular with an optical axis. The optical element may also include an antireflective coating on the first and second opposing curved sides.

Another aspect is directed to a method for making an optical element. The method may include forming via additive manufacturing a lens body having first and second opposing curved sides, and forming via additive manufacturing an annular flange being integral with the lens body and extending radially from the lens body. The annular flange may be parallel with a lens center axis and perpendicular with an optical axis.

Another aspect is directed to an optical device comprising an optical body having first and second opposing sides. The optical device may include a plurality of thermally conductive fingers extending vertically between the first and second opposing sides and through the optical body, and a heatsink carried by the optical body adjacent the first opposing side and coupled to the plurality of thermally conductive fingers. The optical device may also include a thermistor coupled to the optical body. The optical device may comprise a mirror carried by the optical body adjacent the second opposing side.

Another aspect is directed to an optical device. The optical device may comprise a base layer, a plurality of optical integrated circuit (IC) devices carried by the base layer, and a cover layer over the base layer and encapsulating the plurality of optical IC devices. The base layer may comprise a glass substrate.

The typical means of producing optics may not support the requirements for new emerging technologies that require higher resolution. These limitations are imposed by multiple factors, such as the cost for higher-order optics and the inability to improve on the existing manufacturing technology.

Additive manufacturing (AM) is a technology that is used to create three-dimensional parts using a deposition process. AM has been used to create structural elements where the optical transmission was not part of the design constraints. Recently, several approaches have fabricated optical components using AM. These components have been primarily based on organic polymers.

The AM processes that are used to create these components includes the use of inkjet printing with in situ ultraviolet curing and Selective Laser Sintering (SLS) of polymers. The creation of these transmissive optical components has allowed the rapid prototyping of non-imaging optics, display surfaces of arbitrary geometries, and GRadient INdex (GRIN) lenses. While significant progress has been made in printing transparent polymers, polymers are typically used for low cost and low power optics.

Inorganic glass substrates are primarily used in high quality, high power optics because they have high transmissivity. Glass has a lower thermal expansion coefficient and unlike organic polymers, their index of refraction is thermally stable. In addition, glass is amorphous and does have crystalline boundaries for scattering.

The disadvantages of glass is that they have significantly higher processing temperature and they are brittle. They crack easily in cooling process. These limitations makes glass AM much more challenging. In recent years, several approaches have been developed for printing of transparent glass.

With research and development of AM in inorganic glass components, the present disclosure provides an approach to creating optical components with optical functions built into the designs of the optical component itself. In the current manifestation of glass based optical components, the optical functions are done at the surfaces of the component. Take, for example, a mirror; mirrors are either front surface or back surface coated with a reflective media (such Au or Al) and then an antireflection coating is applied to reflective side of the mirror to prevent back reflection into the source.

The process of making a silver mirror is 184 years old. In 1835, German chemist Justus von Liebig developed a process for applying a thin layer of metallic silver to one side of a pane of clear glass. This same technique with some refinement in controlling the geometry of the glass is being used to create most if not all of our inorganic optical components today.

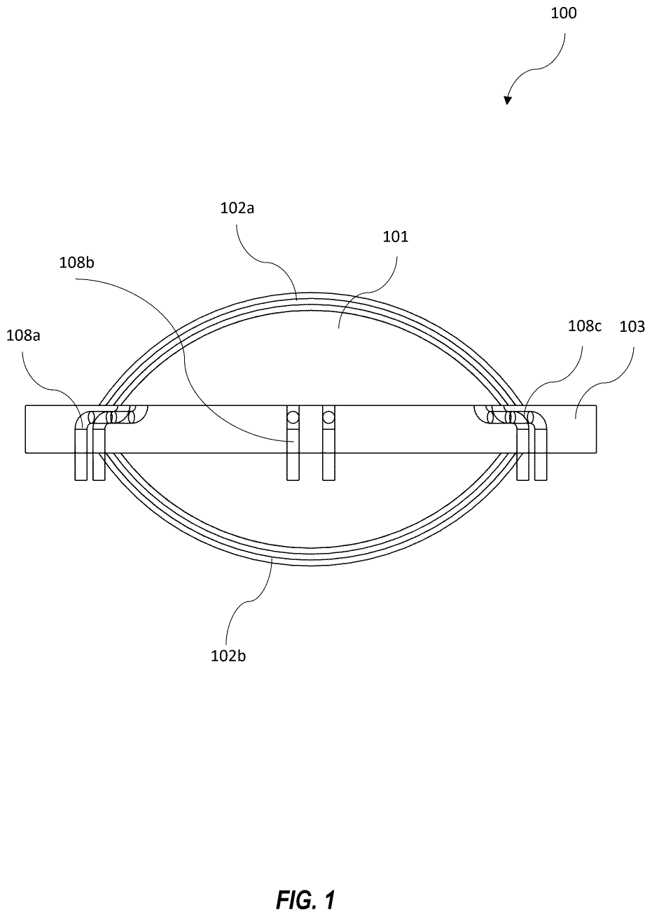

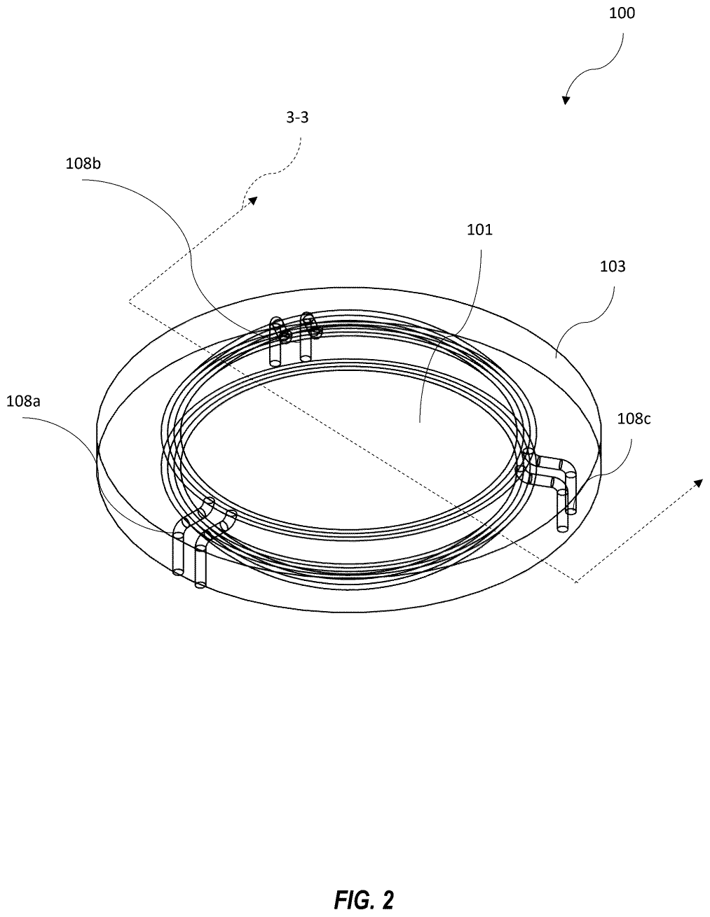

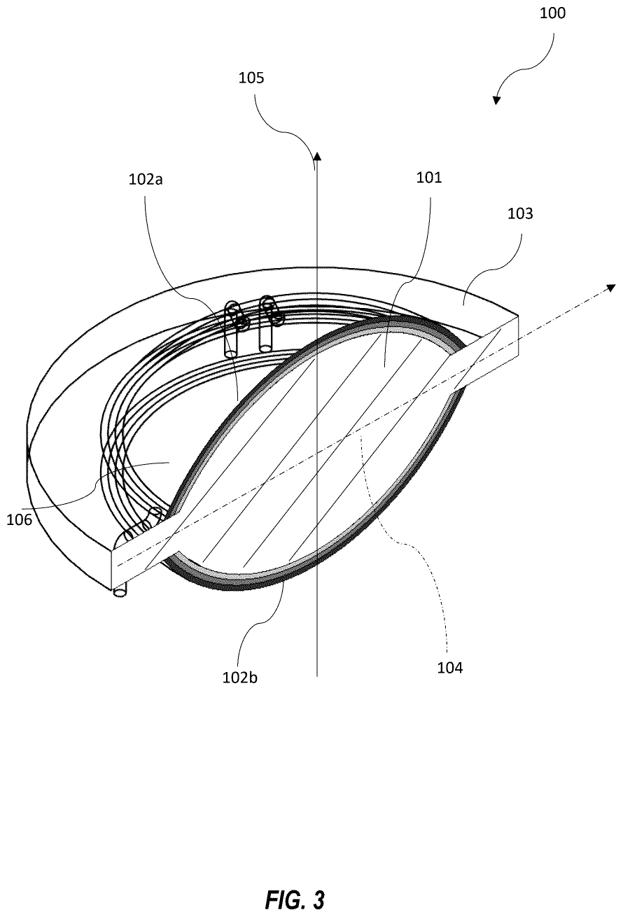

Referring initially to FIGS. 1-3, an optical element 100 according to the present disclosure is now described. As will be detailed herein, the optical element 100 is formed via AM processes (e.g. glass AM deposition). For example, the optical element 100 may be formed as a combination of sequentially formed layers (e.g. the illustrated three layers).

The optical element illustratively includes a lens body 101 having first and second opposing curved sides 102a-102b, and an annular flange 103 being integral with the lens body and extending radially from the lens body. The lens body 101 may comprise an inorganic transparent material. The annular flange 103 is substantially parallel (i.e. ±0.000565° or ±10⁻⁶ radians of parallel) with a lens center axis 104 and substantially perpendicular (i.e. ±0.000565° or ±10⁻⁶ radians of perpendicular) with an optical axis 105.

AM glass deposition allows for the control of the lens center axis 104 relation to the optical axis 105. Generally, and as shown in the illustrated embodiment, the lens center axis 104 and the optical axis 105 are perpendicular to each other. Helpfully, the known relation of the annular flange 103 to the optical axis 105 permits for accurate positioning within an optical device mounting device (e.g. optical lens mount). Moreover, the annular flange 103 may reduce the risk of damage to the optical element 100 during handling.

Also, the optical element 100 is a high definition optical device. This is due to the control of the curvature and purity of the layers, down to the micron layer thickness.

The optical element 100 illustratively comprises an antireflective coating 106 on the first and second opposing curved sides 102a-102b. In some embodiments, the optical element 100 can create the antireflection coating using lens material to change the index of refection of the glass to create the destructive interference of the reflected radiation. During the AM process, the antireflection properties can be grown on the lens body 101 during the deposition process. Also, some embodiments of the optical element 100 can integrate different layers of different index glasses to create a destructive interference for the reflected radiation. Also, the optical element 100 can also integrate different antireflective properties, such as moth eye antireflective effects.

Here, the optical element 100 illustratively includes a plurality of photodiodes 108a-108c carried within the annular flange 103. In some applications, the optical element 100 includes circuitry coupled to the plurality of photodiodes 108a-108c and configured to determine an angle of the optical signal passing therethrough and to determine whether beam steering is needed.

Another aspect is directed to a method for making an optical element 100. The method includes forming via additive manufacturing a lens body 101 having first and second opposing curved sides 102a-102b, and forming via additive manufacturing an annular flange 103 being integral with the lens body and extending radially from the lens body. The annular flange 103 is substantially parallel with a lens center axis 104 and substantially perpendicular with an optical axis 105.

With the use of glass AM deposition method, the geometry of the optical element 100 is grown according to any order mathematical function desired. The optical element 100 may comprise a true diffraction limited optical component (d=2.44*clear aperture/λ.). In addition to controlling the geometry, in some embodiments, AM can create structures that improve the mounting of optical components to non-specialized mounts with a true surface datum transfer assuring angular and positional accuracy.

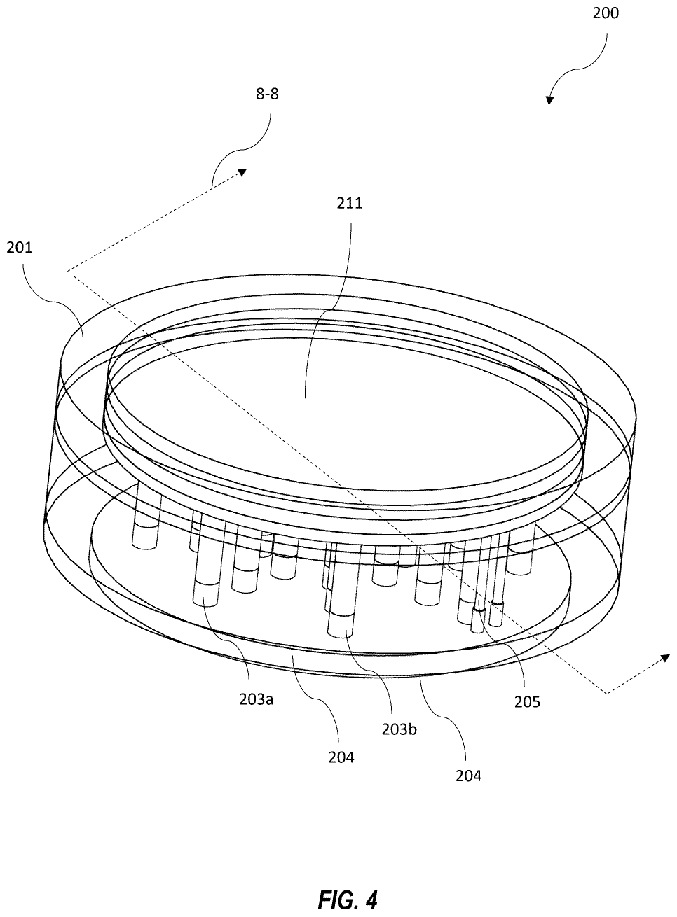

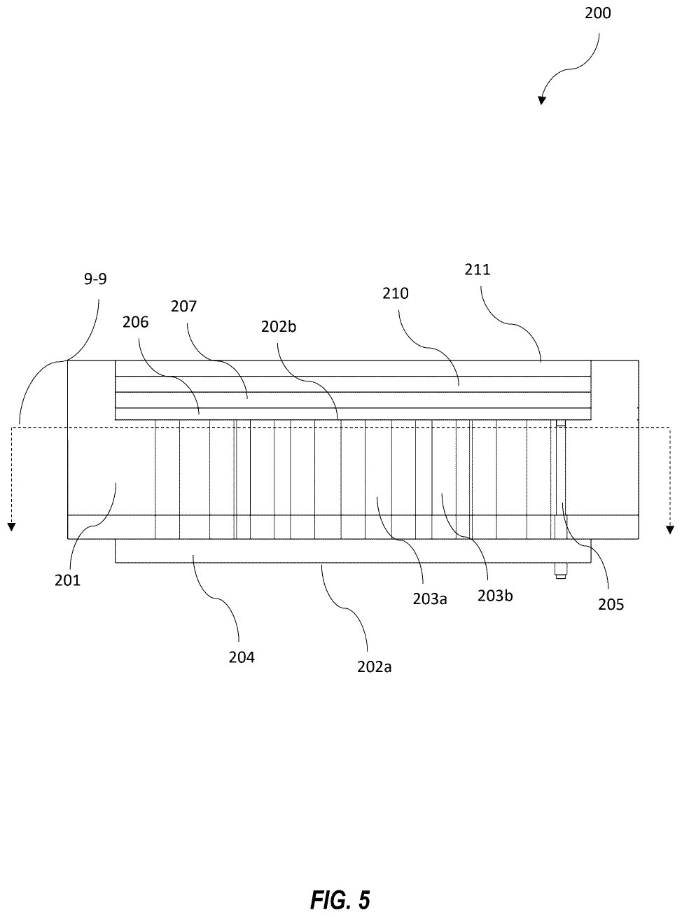

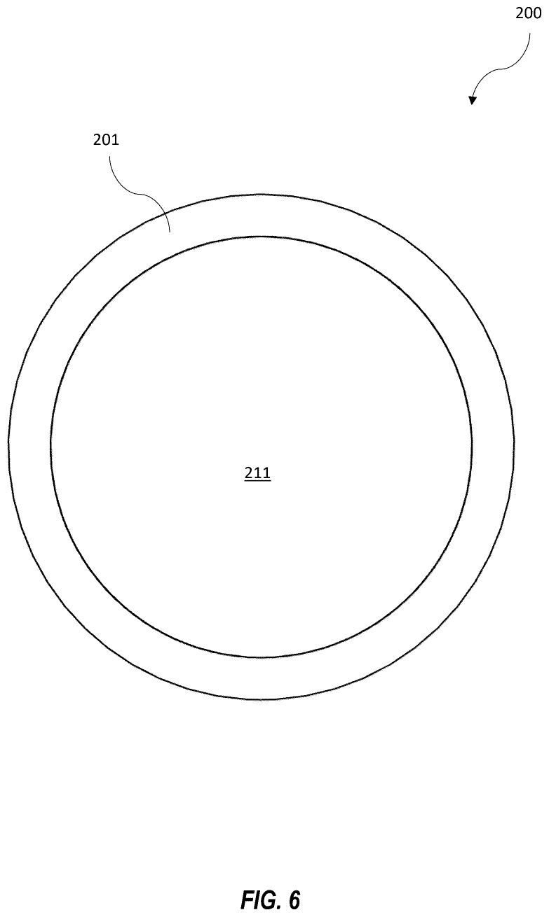

Referring now to FIGS. 4-9, an optical device 200 according to the present disclosure is now described. The optical device 200 illustratively includes an optical body 201 having first and second opposing sides 202a-202b. The optical device 200 illustratively includes a plurality of thermally conductive fingers 203a-203b extending vertically between the first and second opposing sides 202a-202b and through the optical body 201.

The optical device 200 illustratively includes a heatsink 204 carried by the optical body 201 adjacent the first opposing side 202a and coupled to the plurality of thermally conductive fingers 203a-203b (e.g. copper, gold, silver, aluminum). The optical device 200 comprises a thermistor 205 coupled to the optical body 201.

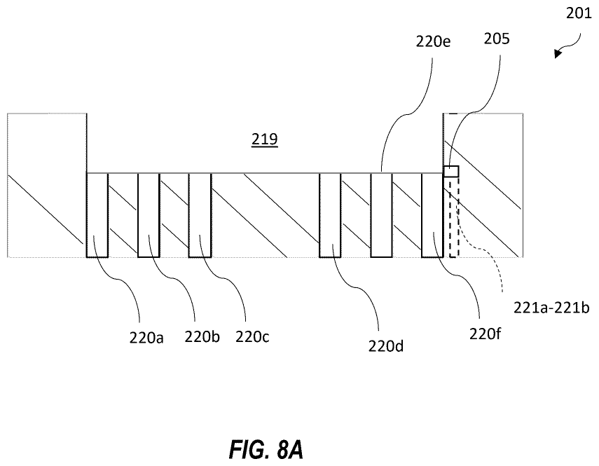

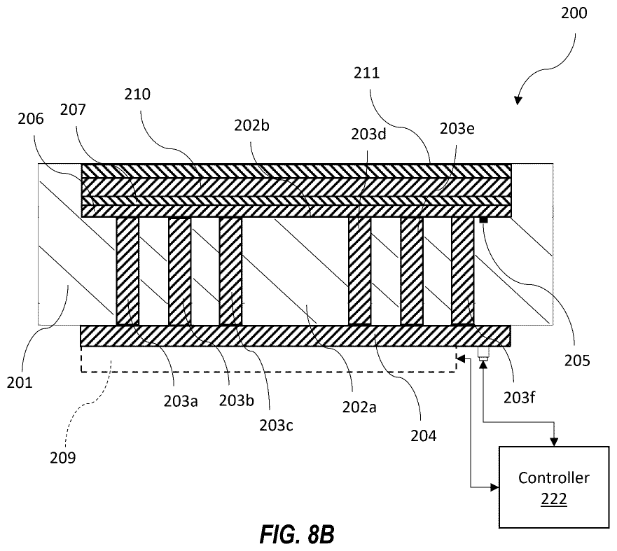

As perhaps best seen in FIG. 8B, the second opposing side 202b of the optical device 200 illustratively comprises a stack of layers. The stack of layers comprises a heat spreader layer 206 carried by the optical body 201 adjacent the second opposing side 202b, and a plurality of cover layers 207, 210, 211. The plurality of cover layers 207, 210, 211 may comprise one or more of a mirror layer, an antireflective coating layer, and a protective layer.

Thermally controlled optics is another manifestation that AM has enabled. By creating cylindrical voids in the bulk glass substrate, one can insert thermal fingers into bulk glass substrate connecting the reflective element and the thermal reservoir. These thermal fingers allows heating or cooling of the active element of the optical component. Additionally, it allows embedding monitoring elements such as thermistors, photodiodes, etc. Additionally, similar to the embodiments of FIGS. 1-3, antireflective properties can be incorporated into this optical element.

With monitoring elements embedded in the optical device 200, a smart optical component is created, where the temperature of the optical component is set and continually monitored. With thermally controlled optics, the operating environment for imaging system or cool the system for high power laser applications can be set and controlled. Additionally, if a photodiode is embedded in the center of the optical component, one can examine the fluence through put of the component in optical alignment procedures and eventually use it track the aging of the component.

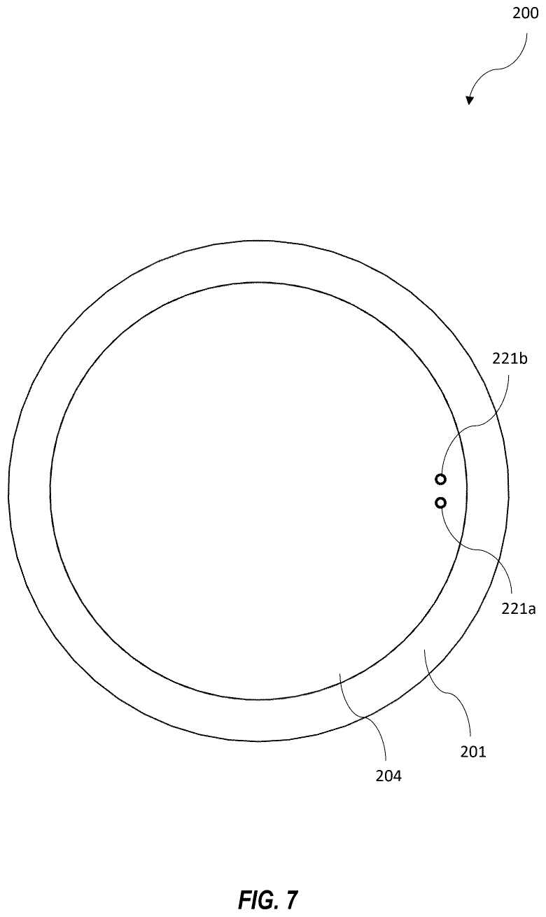

This mirror has a thermistor embedded underneath the reflective surface. As perhaps best seen in FIG. 7, it is also created with a datum transfer surface (e.g. illustrated electrodes).

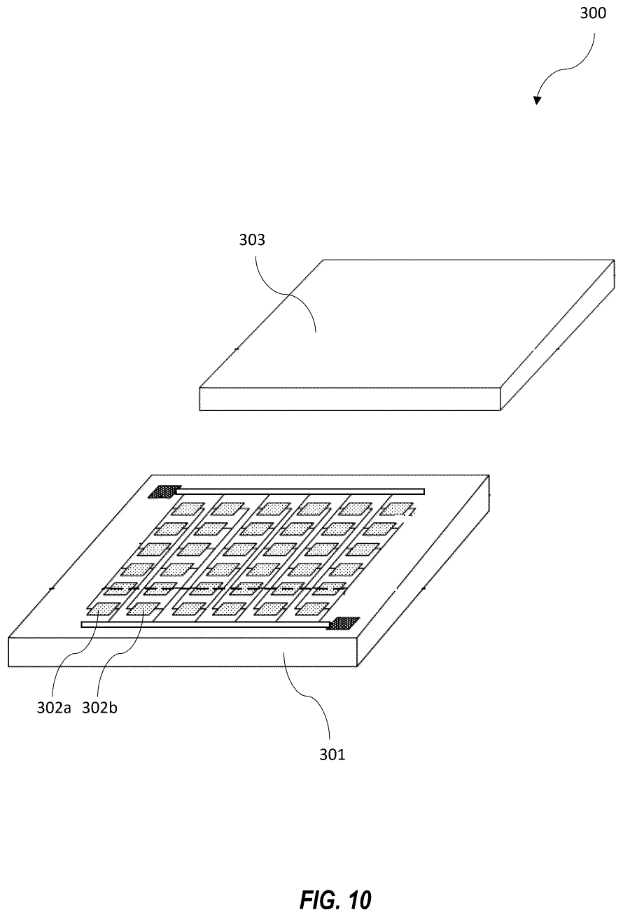

Referring now to FIG. 10, another embodiment of the optical device 300 is now described. This embodiment of the optical device 300 illustratively includes a base layer 301, a plurality of optical IC devices 302a-302n carried by the base layer, and a cover layer 303 over the base layer and encapsulating the plurality of optical IC devices. The base layer 301, and the cover layer 303 may each comprise a glass substrate. Each of the plurality of optical IC devices 302a-302n may comprise one of an LED, a photodetector, a variable optical attenuator, etc.

In some applications, the plurality of optical IC devices 302a-302n may each comprise a liquid crystal (LC) cell or a high definition optical device. Also, each LC cell may comprise a special optical modulation circuit, and/or integrated photonics.

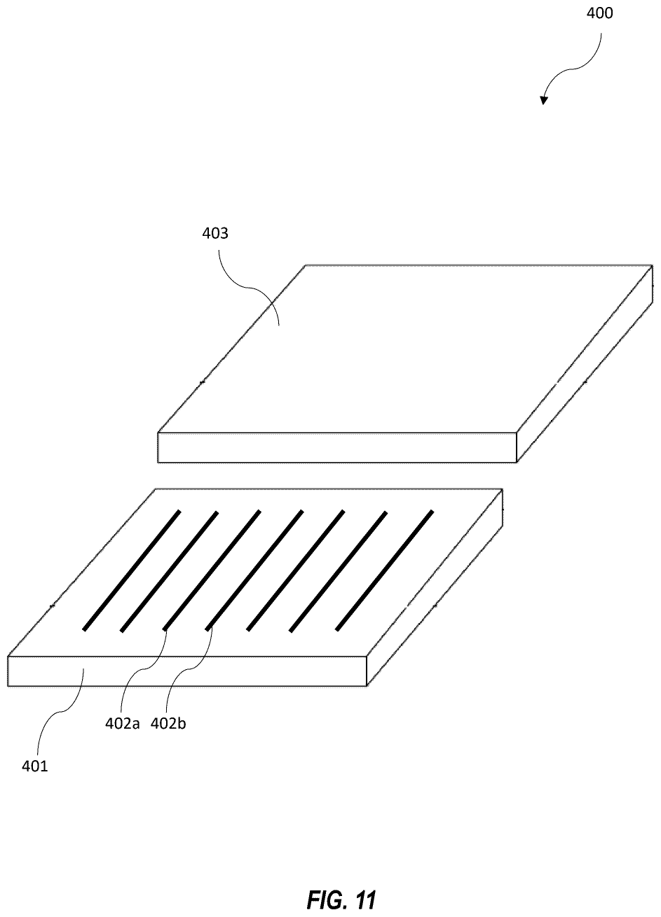

Referring now additionally to FIG. 11, another embodiment of the optical device 400 is now described. In this embodiment of the optical device 400, those elements already discussed above with respect to FIG. 10 are incremented by 100 and most require no further discussion herein. This embodiment differs from the previous embodiment in that this optical device 400 illustratively includes a plurality of bus lines 402a-402b on the base layer 401. The plurality of bus lines 402a-402b may comprise nanometer or micrometer wide bus lines.

These optical devices 300, 400 enhance the optical functionality and performance of AM optical elements. FIGS. 10-11 illustrate this concept. In FIG. 10, a base layer 301 is created by depositing nanoparticles of a transparent material, such as glass using an AM method. On top of this base layer 301, another material is deposited using the AM process to create an active layer. This material can be nanoparticles of metals, semiconductors, ceramics, polymers or optically transparent and electrically conductive material such as Indium-Tin Oxide (ITO). The nanoparticles of these materials are deposited to form the active layer in different geometrical shapes. FIG. 11 shows a row of lines that have very small (nanometer or micrometer) width, and FIG. 10 shows an array square patterns that have very small thickness, width and length.

The distance between two consecutive active layers is very small so that they can interact when a high AC or DC voltage is applied across the active layer, or a light or laser beam is shined on the active layer. Under these conditions, the distribution of electrons changes in the active layer and, consequently, the refractive index of the active layer is modified. Therefore, the active layer affects the propagation of light when light passes from the bottom side to the top side of the base layer. The active layer is protected by depositing the cover layer on top of the active layer using the AM process. In some applications, the optical device 300, 400 can be used as a spatial light modulator.

Regarding the optical element 100, with the ability to control the deposition process, it can be ensured that any slice parallel to center axis of the component is perpendicular to the optical axis of the component. This relationship is preserved when mounting this lens with an optical mount whose contact surface is parallel to the center axis of the lens. The surface datum transfer ensures repeatable pitch and yaw pointing when mounting this optical component. Additionally, it provides a means of handling this component without ever touching the clear aperture of the optical component.

Building different layers of index of refraction using same bulk glass material, an antireflective surface on the optics is provided. This feature ensures that there will be less risk in damaging antireflective properties of the component as opposed to the current method thin film deposition. This feature also ensures that the optical damage threshold for this component is uniform throughout the component by design.

Regarding the optical device 200, by controlling the geometry and the layout out of the optical component, thermally controlled optics and optical fluence monitoring of the optical component are provided. Creating a spatial pattern of void in the bulk material, thermal fingers and electrodes can be inserted. The thermal fingers are connected to a thermal reservoir that can either heat or cool the optical component. Additionally, these fingers are in contact with the active material in the bulk substrate thereby controlling the temperature of the active element of this component. This method of temperature controlled is unique in that it does not introduce localized temperature gradient in the optics.

Also, with having an embedded thermistor that is in contact with active material, one can monitor the temperature of this component. This embedded thermistor provides this component with the ability to be temperature stabilized through an electronic means, such as a Phase Lock Loop (PLL) lock-in amplifier. Additionally, it can be used to monitor the health of the optical component.

The photodiode being embedded in the optical component will help in alignment of the optical component by monitoring the throughput fluence. More important and unique to this component is the ability to detect optical fluence fluctuation along the beam path of the optical train. This feature allows fault detection on the spatial layout of the optical circuit. Using this feature, one can tell real time if it there is power fluctuation of the source radiation or misalignment of the optical component and which component is misaligned.

Regarding the optical devices 300, 400, by introducing active transmissive semiconductor materials that are electrically controlled, one can dynamically control the spatial profile of the radiation and its intensity. Having these semiconductor elements individually addressable one can create unique radiation profiles and active filtering.

The embodiments of the optical element 100 and optical devices 200, 300, 400 disclosed herein may provide the following advantages. By having a monolithic process of creating optical component, this enables the pointing and stabilizing of the optical axis of this component. This enable aligning optical component more easily. Additionally, it reduces the complexity of optical mount, thereby making less expensive and universal.

By having the optical functionality incorporated into the bulk material of the optical component, this reduces the risk of damaging the optical component by handling during the manufacturing and assembling of optical system. It also reduces the amount solvent used to clean and process the optics. More importantly, the optical functions encased in the bulk media are protected from the environmental elements. This is especially important in high fluence operations.

High peak energy in optical pulses (mega joules) creates plasma as it breaks down air near index changing media. With the optical functioning optics free from air, the chance of inducing plasma in optical components are significantly reduced. Take for instance, mirrors that are used to steer optical radiation; they tend to get destroyed with high fluence sources. This is due to the plasma generated at the surface of the component, which damages the metalized reflecting surface.

The sensors embedded in optical components provide real time feedback to the optical system as to the health of the system. It provides a unique diagnostic tool for monitoring the performance of the optical circuit. It can tell you when your components are over heated or if there is a misalignment in your optical train. It also gives you fault location in your optical circuit. These sensors can be used to track the aging of the optical system.

The ability to control the temperature of an optical component significantly opens the door on the amount of energy a component can handle during a specific duration. Additionally, being able to stabilize the temperature of your imaging devices significantly increases the signal to noise ratio on your imaging system thereby increasing the dynamic range of your imaging system. Also, the transparent selectable index material embedded in bulk glass provides a new field of creating custom waveform and intensity profiles using traditional optical component without resorting to specialized crystalized components.

The disclosed embodiments encapsulate the optical function in glass and induce user defined optical functionality to the encapsulated device. Our device is produced by (a) integrating different optical functionalities, (b) growing materials of different optical functionalities, and (c) simultaneously encapsulating/packaging these functionalities into a single optical structure. No post-processing or packaging step is necessary in our invention to produce the final integrated optical device.

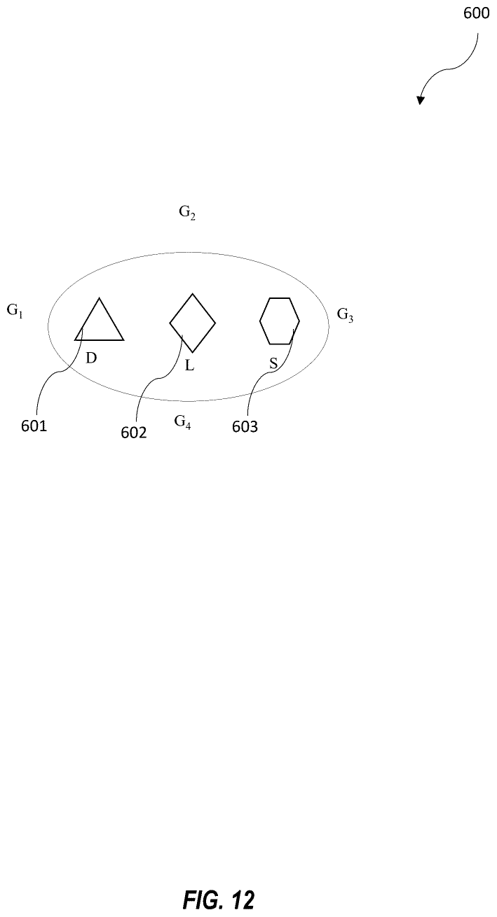

The encapsulant or the packaging material, which could be glass or any other transparent material, is also grown in our invention to induce one or multiple optical functionality to the encapsulant or the packaging material. As an example, FIG. 12 exhibits a multifunctional optical device 600 containing an absorber (e.g., detector, D 601), emitter (e.g., light-emitting diode or laser diode, L 602) and a solar cell (S 603). These optical elements are encapsulated in glass, and the glass structure is grown to create a certain geometrical shape for it to act as a lens in addition to encapsulating the other elements. Different radi of curvature can be created at different regions on the surface G₁G₂G₃G₄ to achieve an optically functional encapsulant with varying focal length at various regions on its surface.

The optical device of our invention can be anisotropic in multiple directions. These features are missing in the typical approaches. These typical approaches present layer by layer deposition of thin films and do not describe the encapsulation or packaging aspect of the device, nor do they describe the dual role of the encapsulant, such as the containment of optical elements and simultaneously providing one or more optical functionality. Also the stack of thin films is not anisotropic in all directions. The stack may be anisotropic in the thickness direction but each film is isotropic on its plane which is perpendicular to the direction of thickness.

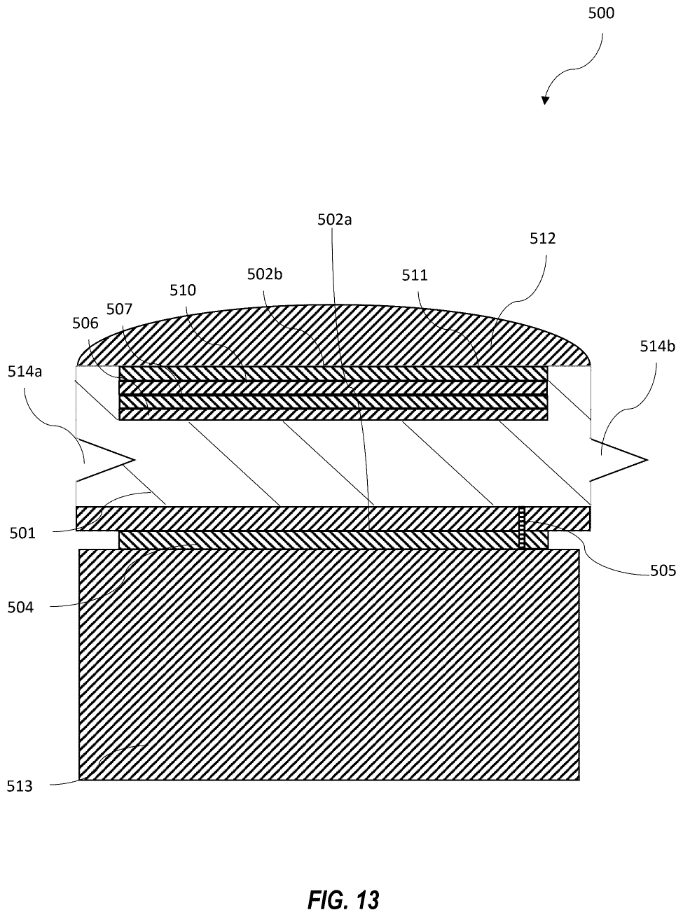

Referring now additionally to FIG. 13, another embodiment of the optical device 500 is now described. In this embodiment of the optical device 500, those elements already discussed above with respect to FIGS. 4-9 are incremented by 300 and most require no further discussion herein. This embodiment differs from the previous embodiment in that this optical device 500 serves as a solar concentrator device. Here, the optical device 500 illustratively comprises a convex lens 512 carried by the second opposing side 502b, and a body 513 abutting the heatsink 504. The convex lens 512 has a focal point within the optical device 500. As will be appreciated, the heatsink 504 conducts thermal energy into the body 513.

In the illustrated embodiment, a large number of the optical devices 500 may be assembled into a tile pattern via interlocking features 514a-514b on opposing sides. Because of the small size scale of the optical device 500, the pattern of the optical devices may be fitted to a variety of surfaces, such as uneven and curved surfaces. In some applications, the pattern of the optical devices may be used to passively heat a large body 513 and thermally isolate the heated reservoir because of the poor thermal conduction of glass (e.g. a water tank). Another aspect is directed to an optical system comprising an array of the optical devices 500.

An optical element comprises a lens body having first and second opposing curved sides, and an annular flange being integral with the lens body and extending radially from the lens body. The annular flange is parallel with a lens center axis and perpendicular with an optical axis. The optical element further comprises an antireflection coating on the first and second opposing curved sides.

A method for making an optical element comprises forming via additive manufacturing a lens body having first and second opposing curved sides, and forming via additive manufacturing an annular flange being integral with the lens body and extending radially from the lens body. The annular flange is parallel with a lens center axis and perpendicular with an optical axis.

An optical device comprises a base layer, a plurality of optical IC devices carried by the base layer, and a cover layer over the base layer and encapsulating the plurality of optical IC devices. The base layer comprises a glass substrate.

Referring again to FIGS. 4-9, an optical device 200 according to the present disclosure is now described. The optical device 200 illustratively includes an optical body 201 having first and second opposing sides 202a, 202b, and a plurality of passageways 220a-220f extending between the first and second opposing sides. As seen in FIG. 8A, the optical body 201 also comprises a plurality of probe passageways 221a, 221b extending between the first and second opposing sides 202a, 202b. The plurality of passageways 220a-220f and the plurality of probe passageways 221a, 221b are each illustratively cylinder-shaped, but may take on other shapes as will be appreciated.

The optical device 200 illustratively comprises a plurality of thermally conductive fingers 203a-203f (e.g. copper, gold, silver, aluminum) extending in the plurality of passageways 220a-220f, and a heatsink 204 (e.g. copper, gold, silver, aluminum) carried by the optical body 201 adjacent the first opposing side 202a and coupled to the plurality of thermally conductive fingers.

The optical device 200 illustratively comprises a heat spreader layer 206 carried by the optical body 201 adjacent the second opposing side 202b and thermally coupled to the plurality of thermally conductive fingers 203a-203f, and a mirror layer 207 (e.g. silver) over the heat spreader layer.

The optical device 200 illustratively comprises an antireflective layer 210 over the mirror layer 207, and a cover layer 211 over the mirror layer 207. The cover layer 211 may comprise a protective layer of glass in some embodiments. As perhaps best seen in FIG. 8A, the optical body 201 defines a circle-shaped flange on the second opposing side 202b with a recess 219 therein. The cover layer 211 defines an air-tight and/or hermetic seal (and temperature stable) for the layers underneath. In embodiments where the cover layer 211 comprises identical glass material as the optical body 201, this may reduce coefficient of thermal expansion (CTE) mismatch and compromising of the seal under operation and thermal stress. Moreover, this process provides for more mechanically robust optics since the cover layer 211 is glass, rather than polymer plastic.

The optical body 201 may comprise an integral glass material. In some embodiments, the optical body 201 and the mirror layer 207 are formed via one or more steps in an additive manufacturing process. In some embodiments, the optical body 201 comprises a contiguous and integral glass material (i.e. a single integral piece), for example.

As will be appreciated, the plurality of thermally conductive fingers 203a-203f thermally conducts thermal energy from the mirror layer 207 to the heatsink 204 for external radiation from the optical device 200.

The optical device 200 further comprises a thermistor 205 coupled adjacent to the second opposing side 202b of the optical body 201. The optical device 200 further comprises a plurality of connection terminals 221a-221b coupled to the thermistor 205 and extending in the plurality of probe passageways 221a, 221b and through the heatsink 204. The optical device 200 illustratively includes a controller 222 coupled to the plurality of connection terminals 221a-221b and configured to sense a temperature of the heat spreader layer 206. As will be appreciated, the controller 222 is configured to monitor the thermal state of the optical device 200.

In the illustrated embodiment, the optical device 200 further comprises an active cooling device 209 (illustrated with dashed lines) carried by the heatsink 204 and coupled to the controller 222. For example, the active cooling device 209 may comprise a thermoelectric cooling element, a fan and finned heatsink structure, or a liquid cooling apparatus. The controller 222 is configured to activate the active cooling device 209 when the temperature of the heat spreader layer 206 exceeds a threshold value.

The heatsink 204 illustratively includes a disc-shaped heatsink abutting the first opposing side 202a of the optical body 201. In other embodiments, the heatsink 204 may have other shapes, including non-planar fin arrangements.

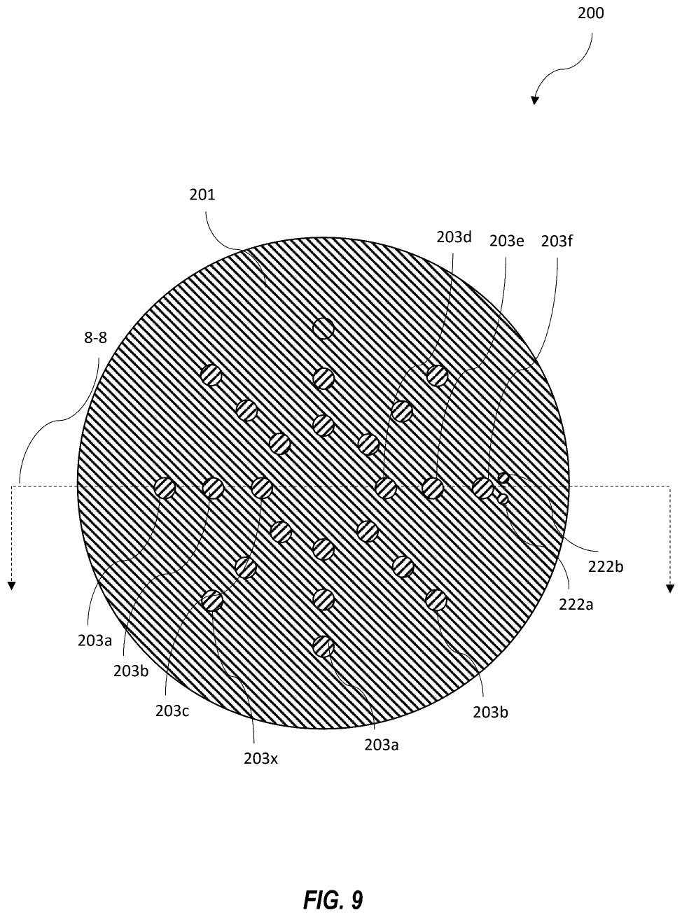

As perhaps best seen in FIG. 9, the plurality of thermally conductive fingers 202a-203x (for drawing clarity, only 203a-203f & 203e-203f and 203x are labeled) may comprise a plurality finger sets (e.g., 203a-203f & 203e-203f), each finger set being radially aligned. In particular, the thermally conductive fingers 202a-203x are arranged in a symmetric star pattern for efficient thermal radiation from the mirror layer 207.

Another aspect is directed to a method for making an optical device 200 comprising forming an optical body 201 having first and second opposing sides 202a, 202b, and a plurality of passageways 220a-220f extending between the first and second opposing sides. In some embodiments, this forming of the optical body 201 comprises one or more additive manufacturing steps. More specifically, the forming of the optical body 201 may comprise an additive manufacturing step using a glass material, for example.

The method comprises forming a plurality of thermally conductive fingers 203a-203f extending in the plurality of passageways 220a-220f and a heat spreader layer 206. The plurality of passageways 220a-220f and the heat spreader layer 206 may comprise an identical thermally conductive material. The method includes forming a mirror layer 207 on the heat spreader layer 206 and carried by the optical body 201 adjacent the second opposing side 202b. The method comprise forming an antireflective layer 210 on the mirror layer 207, and forming a cover layer 211 on the antireflective layer 210.

The method includes coupling a heatsink 204 to be carried by the optical body adjacent the first opposing side 202a and to the plurality of thermally conductive fingers.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. An optical device comprising:
a base layer;
a plurality of active layers on the base layer and comprising a plurality of optical integrated circuit (IC) devices; and
a cover layer over the base layer and encapsulating the plurality of optical IC devices, the base layer and the cover layer each comprising a glass material.

2. The optical device of claim 1 wherein the plurality of active layers is configured to change a refractive index based upon an applied voltage.

3. The optical device of claim 1 wherein the base layer and the plurality of active layers each comprises nanoparticles.

4. The optical device of claim 1 wherein each of the plurality of optical IC devices comprises one of a light emitted diode (LED), a photodetector, and a variable optical attenuator.

5. The optical device of claim 1 wherein each of the plurality of optical IC devices comprises one of a liquid crystal (LC) cell and a high definition optical device.

6. The optical device of claim 1 further comprising a plurality of bus lines the base layer.

7. The optical device of claim 6 wherein each of the plurality of bus lines comprises a nanometer bus line.

8. The optical device of claim 1 wherein the plurality of active layers comprises at least one of a metal material, a semiconductor material, a ceramic material, a polymer material, and an optically transparent electrically conductive material.

9. The optical device of claim 8 wherein the optical transparent electrically conductive material comprises indium tin oxide.

10. An optical device comprising:
a base layer;
a plurality of active layers on the base layer and comprising a plurality of optical integrated circuit (IC) devices, the plurality of active layers configured to change a refractive index based upon an applied voltage; and
a cover layer over the base layer and encapsulating the plurality of optical IC devices, the base layer and the cover layer each comprising a glass material;
wherein the base layer and the plurality of active layers each comprises nanoparticles;
wherein each of the plurality of optical IC devices comprises one of a light emitted diode (LED), a photodetector, and a variable optical attenuator.

11. The optical device of claim 10 wherein each of the plurality of optical IC devices comprises one of a liquid crystal (LC) cell and a high definition optical device.

12. The optical device of claim 10 further comprising a plurality of bus lines the base layer.

13. The optical device of claim 12 wherein each of the plurality of bus lines comprises a nanometer bus line.

14. The optical device of claim 10 wherein the plurality of active layers comprises at least one of a metal material, a semiconductor material, a ceramic material, a polymer material, and an optically transparent electrically conductive material.

15. The optical device of claim 14 wherein the optical transparent electrically conductive material comprises indium tin oxide.

16. A method for making an optical device, the method comprising:
depositing nanoparticles of a first material via an additive manufacturing process to form a base layer;
depositing nanoparticles of a second material via an additive manufacturing process to form a plurality of active layers on the base layer, the plurality of active layers comprising a plurality of optical integrated circuit (IC) devices; and
depositing nanoparticles of a second material via an additive manufacturing process to form a cover layer over the base layer and encapsulating the plurality of optical IC devices, the base layer and the cover layer each comprising a glass material.

17. The method of claim 16 wherein the plurality of active layers is configured to change a refractive index based upon an applied voltage.

18. The method of claim 16 wherein the base layer and the plurality of active layers each comprises nanoparticles.

19. The method of claim 16 wherein each of the plurality of optical IC devices comprises one of a light emitted diode (LED), a photodetector, and a variable optical attenuator.

20. The method of claim 16 wherein each of the plurality of optical IC devices comprises one of a liquid crystal (LC) cell and a high definition optical device.
